(19) United States
(12) Patent Application Publication
(10) Pub. No.: US 2013/0050316 A1
(43) Pub. Date: Feb. 28, 2013

(54) POWER MANAGEMENT DEVICE FOR PRINTING SYSTEM

(71) Applicant: Richard A. Murray, San Diego, CA (US)

(72) Inventor: Richard A. Murray, San Diego, CA (US)

(21) Appl. No.: 13/215,595

(22) Filed: Aug. 23, 2011

(51) Int. Cl. B41J 29/38

(52) U.S. Cl. 347/10

(57) ABSTRACT

A printing system includes a printhead having a printing voltage input and a printhead logic voltage input; a DC power supply including a first DC voltage level; and a power management integrated circuit including a controllably on/off voltage output connected to the printing voltage input of the printhead; a DC to DC voltage conversion circuit to internally generate a second DC voltage level that is different from the first DC voltage level; and a controllably on/off voltage output connected to the printhead logic voltage input.

### FIELD OF THE INVENTION

The present invention relates generally to power management for a printing system, and more particularly to an integrated circuit for power management for a printing system.

### BACKGROUND OF THE INVENTION

An inkjet printing system typically includes one or more printheads and their corresponding ink supplies. Each printhead includes an ink inlet that is connected to its ink supply and an array of drop ejectors, each ejector consisting of an ink pressurization chamber, an ejecting actuator and a nozzle through which droplets of ink are ejected. The ejecting actuator may be one of various types, including a heater that vaporizes some of the ink in the pressurization chamber in order to propel a droplet out of the orifice, or a piezoelectric device which changes the wall geometry of the chamber in order to generate a pressure wave that ejects a droplet. The droplets are typically directed toward paper or other recording medium in order to produce an image according to image data that is converted into electronic firing pulses for the drop ejectors as the recording medium is moved relative to the printhead.

A common type of printer architecture is the carriage printer, where the printhead nozzle array is somewhat smaller than the extent of the region of interest for printing on the recording medium and the printhead is mounted on a carriage. In a carriage printer, the recording medium is advanced a given distance along a media advance direction and then stopped. While the recording medium is stopped, the printhead carriage is moved in a direction that is substantially perpendicular to the media advance direction as the drops are ejected from the nozzles. After the carriage has printed a swath of the image while traversing the recording medium, the recording medium is advanced; the carriage direction of motion is reversed, and the image is formed swath by swath.

Printing systems typically require DC power at a plurality of different voltages. The voltage required for the firing pulses for the drop ejectors in the printhead is typically between 10 volts and 50 volts, depending upon the design of the drop ejectors. Many printheads include driving and logic electronics that is integrated within the same printhead die that includes the drop ejectors. The logic electronics of the printhead requires a DC voltage that is typically between 2 volts and 6 volts. System logic requires a DC voltage that can be around 3.3 volts. Memory, such as DRAM, can require a DC voltage around 2 volts. For systems having a digital integrated circuit serving as the controller (sometimes called a system on chip or SOC), a core voltage of around 1 V is typically required for the SOC. Rather than generating each of these different DC voltages directly from the 110 volt AC input voltage, more typically a regulated power supply generates a DC voltage that is approximately equal to the highest DC voltage required in the system, and then DC to DC conversion is used to provide the other regulated DC voltage levels.

One type of DC to DC conversion circuit is the buck converter shown in FIG. 1. When power MOSFET Q is turned on, current begins flowing from the input source Vᵢₙ through Q, through inductor L, charging capacitor C and into the load. The magnetic field in inductor L builds up, storing energy in the inductor. When power MOSFET Q is turned off, inductor L opposes any drop in current by suddenly reversing its EMF. As a result, it supplies current to the load through the flyback diode D (typically a Schottky diode). The DC voltage Vₒᵤₜ across the load is the input voltage Vᵢₙ times the switching duty cycle.

Although it is possible to provide a buck converter or other type of switching mode power supply for each of the required DC voltages, a more economical approach is to integrate some of the components for each of the DC to DC conversion circuits onto a power management integrated circuit (sometimes called an analog controller chip). In particular, the power MOSFETs and the switching control circuits can be incorporated into the power management IC.

Typically, however the inductors, capacitors and flyback diodes are provided as discrete components. These discrete components and their assembly take additional space and incur additional expense.

What is needed is a power management IC that provides at least a portion of the DC to DC conversion entirely on the IC without requiring additional discrete components.

### SUMMARY OF THE INVENTION

The present invention is directed to overcoming one or more of the problems set forth above. Briefly summarized, according to one aspect of the invention, the invention resides in a printing system comprising a printhead including a printing voltage input and a printhead logic voltage input; a DC power supply including a first DC voltage level; and a power management integrated circuit comprising a controllably on/off voltage output connected to the printing voltage input of the printhead; a DC to DC voltage conversion circuit to internally generate a second DC voltage level that is different from the first DC voltage level; and a controllably on/off voltage output connected to the printhead logic voltage input.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is a circuit diagram for a buck converter for DC to DC voltage level conversion;

FIG. 2 is a schematic representation of an inkjet printer system;

FIG. 3 is a perspective view of a portion of a printhead;

FIG. 4 is a perspective view of a portion of a carriage printer;

FIG. 5 is a schematic side view of an exemplary paper path in a carriage printer;

FIG. 6 is a perspective view of a multifunction printer;

FIG. 7 is a cutaway view of the multifunction printer of FIG. 6 with the automatic document feeder raised;

FIG. 8 is a block diagram of prior art power management and control circuitry for a multifunction printer;

FIG. 9 is a block diagram of power management and control circuitry for a multifunction printer according to an embodiment of the invention;

FIGS. 10A and 10B are simplified schematics of charge pumps at different points in the charge cycle; and

FIGS. 11A and 11B are power pulses and voltage pulses for compensation for different printhead resistances according to an embodiment of the invention.

### DETAILED DESCRIPTION OF THE INVENTION

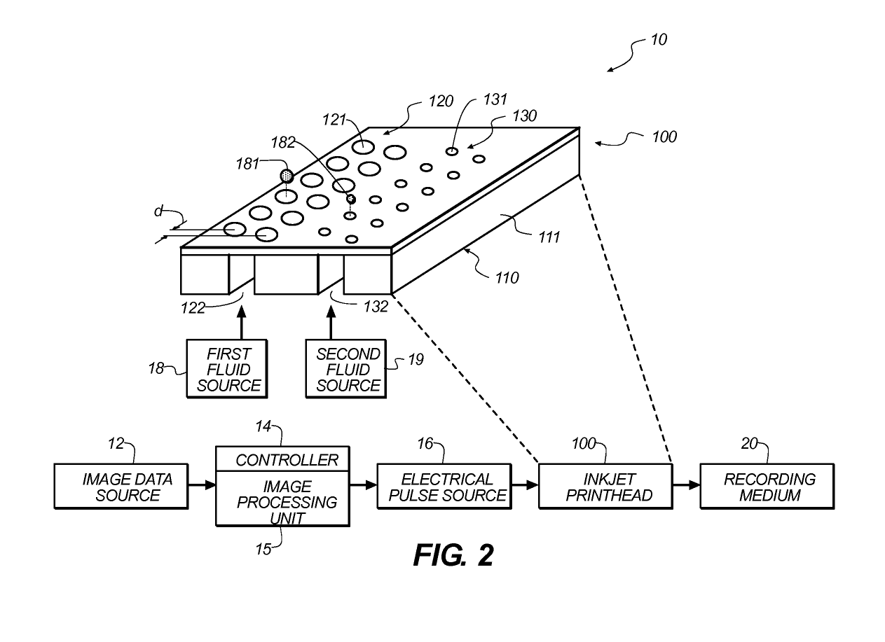

Referring to FIG. 2, a schematic representation of an inkjet printer system 10 is shown, for its usefulness with the present invention and is fully described in U.S. Pat. No. 7,350,902, and is incorporated by reference herein in its entirety. An inkjet printer system 10 includes an image data source 12, which provides data signals that are interpreted by a controller 14 as being commands to eject drops. At least a portion of controller 14 can be integrated as a system on chip (SOC) integrated circuit. Controller 14 includes an image processing unit 15 for rendering images for printing, and outputs signals to an electrical pulse source 16 of electrical energy pulses that are inputted to an inkjet printhead 100, which includes at least one inkjet printhead die 110. Printhead die 110 can include driver circuitry and logic circuitry, and an ejector voltage can be provided to the drop ejectors on the printhead 100, such that upon appropriate clock pulses, data pulses, and fire enable pulses from controller 14, electrical pulses are provided to the drop ejectors. In such cases, electrical pulse source 16 includes the ejector voltage supply, as well as electronics integrated into printhead die 110.

In the example shown in FIG. 2, there are two nozzle arrays. Nozzles 121 in a first nozzle array 120 have a larger opening area than nozzles 131 in a second nozzle array 130. In this example, each of the two nozzle arrays 120, 130 has two staggered rows of nozzles, each row having a nozzle density of 600 per inch. The effective nozzle density then in each array is 1200 per inch (i.e. d= 1/1200 inch in FIG. 2). If pixels on a recording medium 20 were sequentially numbered along the paper advance direction, the nozzles from one row of an array would print the odd numbered pixels, while the nozzles from the other row of the array would print the even numbered pixels.

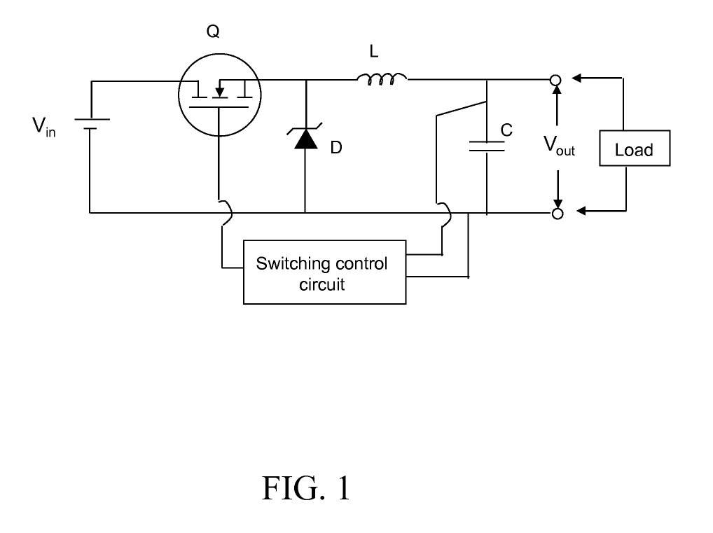

In fluid communication with each nozzle array 120, 130 is a corresponding ink delivery pathway. An ink delivery pathway 122 is in fluid communication with the first nozzle array 120, and ink delivery pathway 132 is in fluid communication with the second nozzle array 130. Portions of ink delivery pathways 122 and 132 are shown in FIG. 1 as openings through a printhead die substrate 111. One or more inkjet printhead die 110 will be included in inkjet printhead 100, but for greater clarity only one inkjet printhead die 110 is shown in FIG. 2. In FIG. 2, a first fluid source 18 supplies ink to first nozzle array 120 via ink delivery pathway 122, and a second fluid source 19 supplies ink to second nozzle array 130 via ink delivery pathway 132. Although distinct fluid sources 18 and 19 are shown, in some applications it can be beneficial to have a single fluid source supplying ink to both the first nozzle array 120 and the second nozzle array 130 via ink delivery pathways 122 and 132 respectively. Also, in some embodiments, fewer than two or more than two nozzle arrays 120, 130 can be included on printhead die 110. In some embodiments, all nozzles on inkjet printhead die 110 can be the same size, rather than having multiple sized nozzles on inkjet printhead die 110.

Not shown in FIG. 1, are the drop forming mechanisms associated with the nozzles. Drop forming mechanisms can be of a variety of types, some of which include a resistive heating element to vaporize a portion of ink and thereby cause ejection of a droplet, or a piezoelectric transducer to constrict the volume of a fluid chamber and thereby cause ejection, or an actuator which is made to move (for example, by heating a bi-layer element) and thereby cause ejection. In any case, electrical pulses from electrical pulse source 16 are sent to the various drop ejectors according to the desired deposition pattern. In the example of FIG. 2, droplets 181 ejected from the first nozzle array 120 are larger than droplets 182 ejected from the second nozzle array 130, due to the larger nozzle opening area. Typically other aspects of the drop forming mechanisms (not shown) associated respectively with nozzle arrays 120 and 130 are also sized differently in order to optimize the drop ejection process for the different sized drops. During operation, droplets of ink are deposited on a recording medium 20.

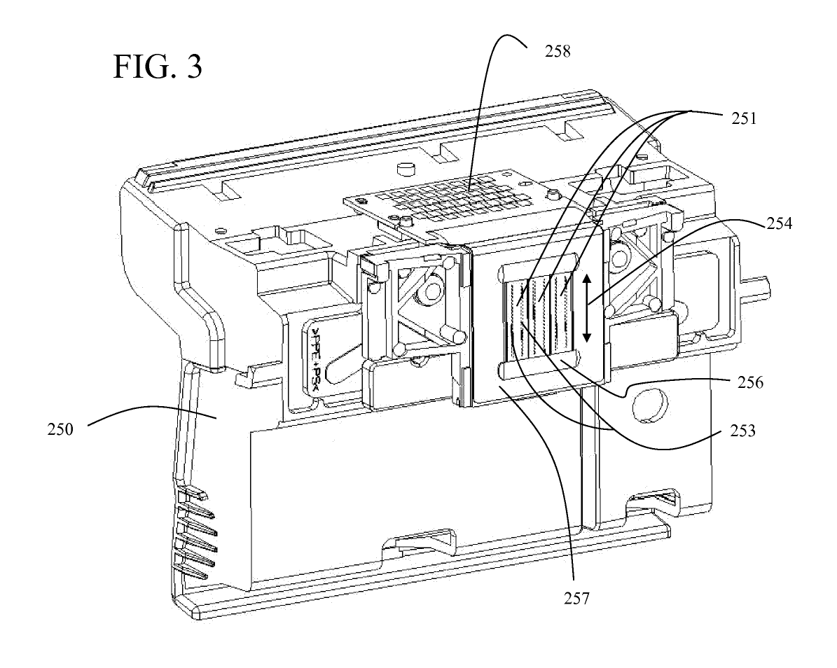

FIG. 3 shows a perspective view of a portion of a printhead 250, which is an example of the inkjet printhead 100. Printhead 250 includes three printhead die 251 (similar to printhead die 110 in FIG. 2), each printhead die 251 containing two nozzle arrays 253, so that printhead 250 contains six nozzle arrays 253 altogether. The six nozzle arrays 253 in this example can each be connected to separate ink sources (not shown in FIG. 3); such as cyan, magenta, yellow, text black, photo black, and a colorless protective printing fluid. Each of the six nozzle arrays 253 is disposed along nozzle array direction 254, and the length of each nozzle array 253 along the nozzle array direction 254 is typically on the order of 1 inch or less. Typical lengths of recording media are 6 inches for photographic prints (4 inches by 6 inches) or 11 inches for paper (8.5 by 11 inches). Thus, in order to print a full image, a number of swaths are successively printed while moving printhead 250 across the recording medium 20. Following the printing of a swath, the recording medium 20 is advanced along a media advance direction that is substantially parallel to nozzle array direction 254.

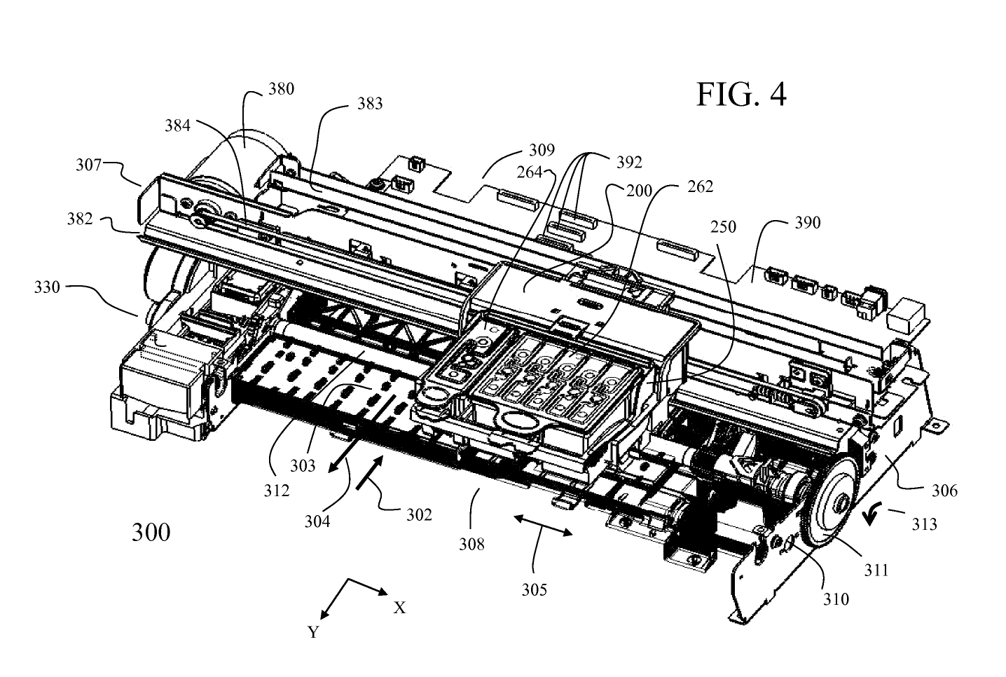

Also shown in FIG. 3 is a flex circuit 257 to which the printhead die 251 are electrically interconnected, for example, by wire bonding or TAB bonding. The interconnections are covered by an encapsulant 256 to protect them. Flex circuit 257 bends around the side of printhead 250 and connects to a connector board 258. When printhead 250 is mounted into a carriage 200 (see FIG. 4), a connector board 258 is electrically connected to a connector (not shown) on the carriage 200, so that electrical signals can be transmitted to the printhead die 251.

FIG. 4 shows a portion of a desktop carriage printer. Some of the parts of the printer have been hidden in the view shown in FIG. 4 so that other parts can be more clearly seen. A printer chassis 300 has a print region 303 across which carriage 200 is moved back and forth in carriage scan direction 305 along the X axis, between the right side 306 and the left side 307 of printer chassis 300, while drops are ejected from printhead die 251 (not shown in FIG. 4) on printhead 250 that is mounted on carriage 200. A carriage motor 380 rotates in forward and reverse directions to move a belt 384 to move carriage 200 back and forth along a carriage guide rail 382. An encoder sensor (not shown) is mounted on carriage 200 and indicates carriage location relative to an encoder fence 383. Printhead 250 is mounted in carriage 200, and a multi-chamber ink supply 262 and a single-chamber ink supply 264 are mounted in the printhead 250. The mounting orientation of printhead 250 is rotated relative to the view in FIG. 3, so that the printhead die 251 are located at the bottom side of printhead 250, the droplets of ink being ejected downward onto the recording medium in print region 303 in the view of FIG. 4. Multi-chamber ink supply 262, in this example, contains five ink sources: cyan, magenta, yellow, photo black, and colorless protective fluid; while single-chamber ink supply 264 contains the ink source for text black. Paper or other recording medium (sometimes generically referred to as paper or media herein) is loaded along a paper load entry direction 302 toward the front of a printer chassis 308.

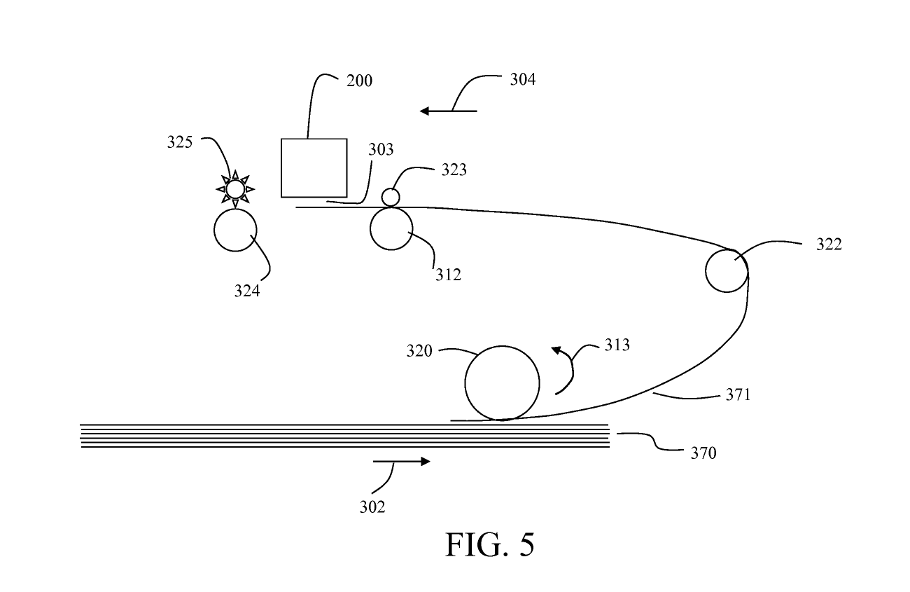

A variety of rollers are used to advance the medium through the printer as shown schematically in the side view of FIG. 5. In this example, a pick-up roller 320 moves the top piece or sheet 371 of a stack 370 of paper or other recording medium in the direction of arrow, paper load entry direction 302. A turn roller 322 acts to move the paper around a C-shaped path (in cooperation with a curved rear wall surface) so that the paper continues to advance along media advance direction 304 from the rear 309 of the printer chassis 308 (with reference also to FIG. 4). The paper is then moved by a feed roller 312 and idler roller(s) 323 to advance along the Y axis across print region 303, and from there to a discharge roller 324 and star wheel(s) 325 so that printed paper exits along media advance direction 304. Feed roller 312 includes a feed roller shaft along its axis, and feed roller gear 311 is mounted on the feed roller shaft. Feed roller 312 can include a separate roller mounted on the feed roller shaft, or can include a thin high friction coating on the feed roller shaft. A rotary encoder (not shown) can be coaxially mounted on the feed roller shaft in order to monitor the angular rotation of the feed roller.

The motor that powers the paper advance rollers is not shown in FIG. 4, but a hole 310 at the right side of the printer chassis 306 is where the motor gear (not shown) protrudes through in order to engage a feed roller gear 311, as well as the gear for the discharge roller (not shown). For normal paper pick-up and feeding, it is desired that all rollers rotate in forward rotation direction 313. For deskewing the recording medium, in some modes the feed roller 312 and the discharge roller 324 are rotated in reverse while the turn roller 322 is rotated forward. Toward the left side of the printer chassis 307, in the example of FIG. 4, is a maintenance station 330.

Toward the rear of the printer chassis 309, in this example, is located an electronics board 390, which includes cable connectors 392 for communicating via cables (not shown) to the printhead carriage 200 and from there to the printhead 250. Also on the electronics board are typically mounted motor controllers for the carriage motor 380 and for the paper advance motor, a processor and/or other control electronics (shown schematically as controller 14 and image processing unit 15 in FIG. 1) for controlling the printing process, a power management IC, and an optional connector for a cable to a host computer. Optionally the motor controllers can be integrated onto the power management IC.

Many printing systems include scanning, copying and optionally faxing capabilities as well as printing capabilities. Such multifunction printers include an optical scanner. Optical scanners operate by imaging an object (e.g. a document) with a light source, and sensing a resultant light signal with an optical sensor array (also called a photosensor array herein). Each optical sensor or photoreceptor in the array generates a data signal representative of the intensity of light impinged thereon for a corresponding portion of the imaged object. The data signals from the array sensors are then processed (typically digitized) and stored in a temporary memory such as a semiconductor memory or on a hard disk of a computer, for example, for subsequent manipulation and printing or display, such as on a computer monitor. The image of the scanned object is projected onto the photosensor array incrementally by use of a moving scan line. The moving scan line is produced either by moving the document with respect to a scan assembly, or by moving the scan assembly relative to the document.

One type of scan assembly is the contact image sensor (CIS) including a photosensor array having a length that is substantially equal to the width of the scanning region. The photosensors in a CIS are substantially the same size as the pixel resolution of the scanner. A low power light source (such as one or more LED's) is sufficient to provide enough illumination in the scan line image region. The CIS has a short depth of field and is typically mounted beneath the transparent platen upon which the document is placed. One or more rollers in the CIS carriage are biased against the bottom of the transparent platen so that the CIS is always at substantially the same distance from the top of the transparent platen.

In addition, when working with cut sheet print media, a multifunction printing apparatus can provide automatic document feed, as well as manual document placement capabilities. An automatic document feeder (ADF) mechanism is capable of automatically loading and unloading single sheets sequentially to a functional station where the apparatus performs an operation, e.g., sequentially scanning the fed document sheets for copying, faxing, displaying on a computer monitor, or the like. Following the operation, the ADF then off-loads a sheet and feeds the immediately following sheet of the document to the functional station. A sequential flow of sheets by the ADF and positioning without the necessity of manual handling reduces the time required to accomplish the complete functional operation.

Each document fed into the ADF is conveyed to an automatic scanning region where the document is scanned by a photosensor array and then the document is conveyed to a point outside the ADF, such as a document output tray. During ADF operation, the photosensor array remains fixed at the automatic scanning region “reading” or scanning the image as the document is conveyed past the scanning point by the ADF. During manual scanning, the document lays flat on and covers a portion of the flat platen while the photosensor array is moved under the platen the length (or width) of the document to read or scan the document.

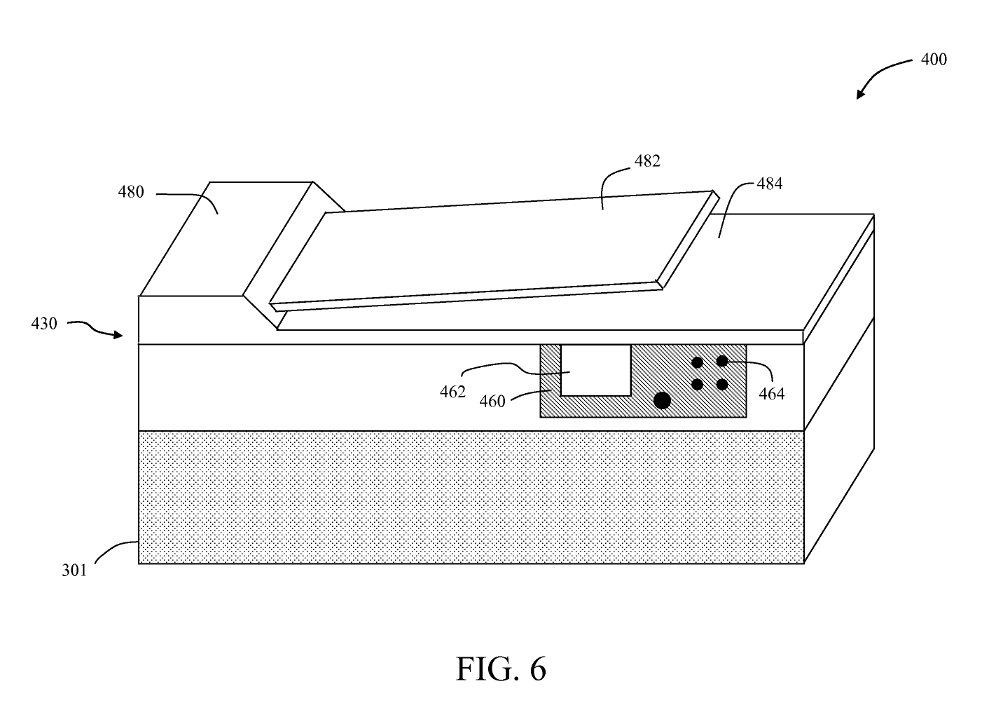

FIG. 6 shows a perspective view of a multifunction printer 400 including a scanning apparatus 430, an ADF 480, and a printing apparatus 301, such as an inkjet printer. Multifunction printer 400 can do printing, scanning of documents, or copying of documents (i.e. printing plus scanning) ADF 480 includes an input tray 482 where documents for scanning or copying are stacked, output tray 484 for receiving scanned documents. A control panel 460 includes a display 462 and a variety of control buttons 464 with which the user can provide a variety of instructions.

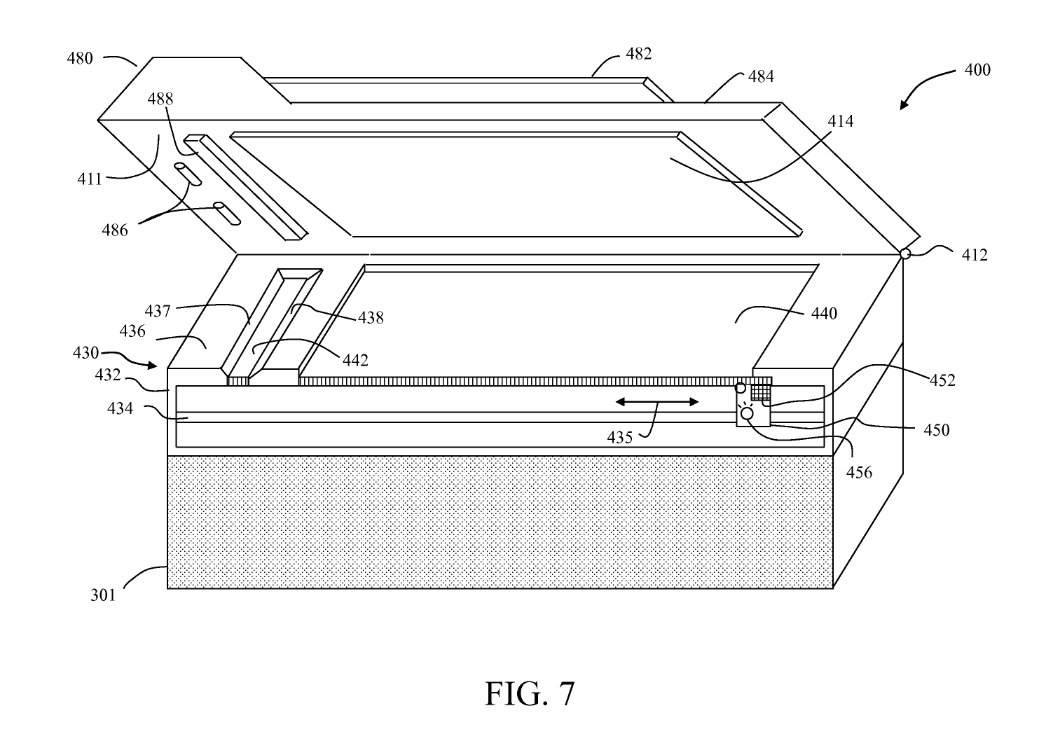

As shown in the cutaway view of FIG. 7 (similar to FIG. 6 but with the ADF 480 raised up), ADF 480 can be attached to scanning apparatus body 432 of scanning apparatus 430 by a hinge 412, so that the under side 411 of ADF 480 can function as a lid for scanning apparatus 430. The surface of scanning apparatus body 432 that is covered by under side 411 of ADF 480 when ADF 480 is closed includes a frame 436. A transparent platen 440 (typically a flat piece of glass) is inset within the frame 436. The front of scanning apparatus 430 is cut away in FIG. 7 in order to show movable scan assembly 450 below transparent platen 440. Scan assembly 450 includes a photosensor array 452 (such as a contact image sensor) extending the width of the transparent platen 440, and a light source 456 that illuminates a scan line of a document or other item (not shown) that is placed on top of transparent platen 440. A light guide and other optics (not shown) can also be included in scan assembly 450. Scan assembly 450 is moved back and forth along a scanning guide 434 in a scanning direction 435 across the length of transparent platen 440 in order to scan the document or other item, receiving reflected light from the item through the transparent platen 440 scan line by scan line and converting the reflected light into electrical signals. A controller, at least of portion of which can be included in the system on chip, converts the electrical signals into digitized data to form a digitized image of the item. Scanning guide 434 can be a round rail, a rack and pinion or other guiding member that can use the power of a motor (not shown) to provide a linear motion along the scanning direction 435. A pressing plate 414 is affixed to under side 411. Pressing plate 414 can be compressible and/or it can be resiliently mounted so that an item to be manually scanned is pressed against transparent platen 440. A separate ADF transparent platen 442 is provided for scanning documents being fed by ADF 480. The document to be scanned is moved by a transporter such as rollers 486 down a down ramp 437, across the ADF transparent platen 442, up an up ramp 438 and toward a slot (not shown) on the underside 411 through which it passes on its way to an output tray 484. A pressing member 488 forces the document into contact with ADF transparent platen 442 for scanning by scan assembly 450, which is parked below ADF transparent platen 442 during ADF scanning

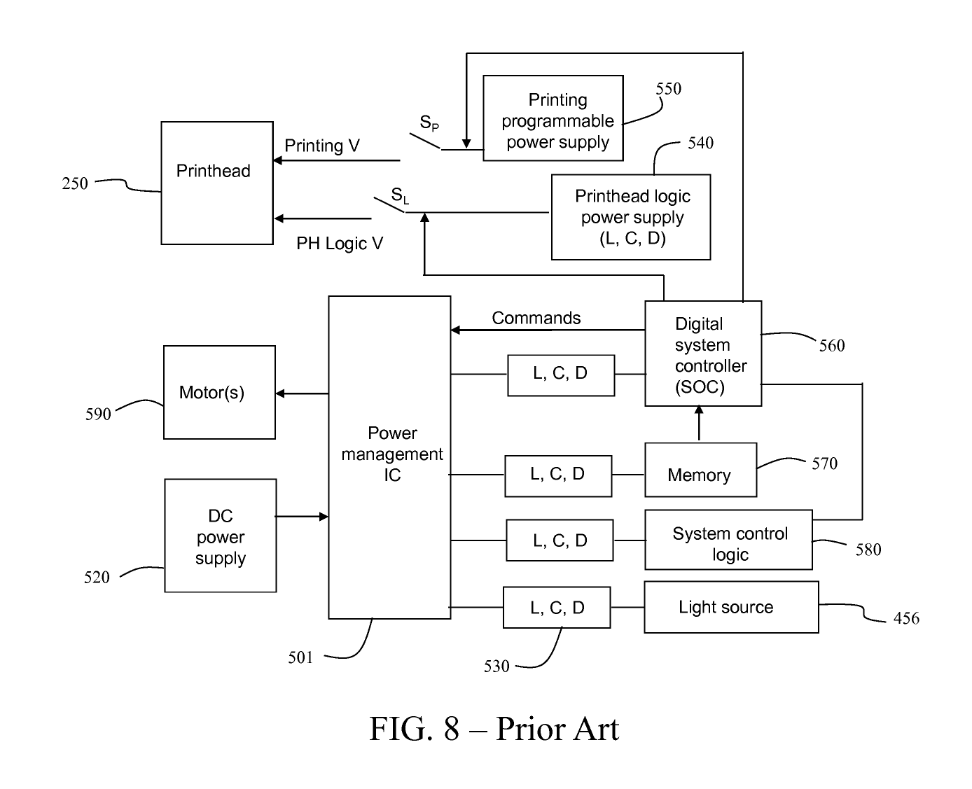

A block diagram of power management and control circuitry for a prior art multifunction printer is shown in FIG. 8. A DC power supply 520 provides a regulated DC voltage to a power management IC 501. Typically, the voltage provided by DC power supply 520 is approximately equal to the highest DC voltage required in the multifunction printer. Other DC voltage levels are provided by DC to DC conversion. As described in the background, although it is possible to provide a buck converter (FIG. 1) or other type of switching mode power supply for each of the required DC voltages, a more economical approach is to integrate some of the components for each of the DC to DC conversion circuits onto the power management integrated circuit 501. In particular, the power MOSFETs and the switching control circuits can be incorporated into the power management IC 501. Typically, however the inductors L, capacitors C and flyback diodes D are provided as discrete components 530 for each of the different required voltages. Several different system components are shown in FIG. 8 having different DC voltage requirements. Core voltage for the system on chip digital system controller 560 is typically around 1 volt. The digital system controller 560 not only receives its voltage input from the power management IC 501, but also provides commands to the power management IC 501. Dynamic RAM memory 570 typically requires around 2 volts. System control logic 580 (some or all of which can be incorporated on the digital system controller 560) typically requires around 3.3 volts. ROM memory typically requires around 3 volts for reading and can typically use the same voltage source as system logic 580. Light source 456 (FIG. 7) for the scan assembly 450 can require around 5 volts. Red LEDs and green LEDs turn on at a lower voltage and can use the 3.3 volts generated for system logic 580. However, a blue LED turns on at approximately 3 volts. If a switch (not shown) is in series with the blue LED for turning the blue LED on and off, around 5 volts is preferred. For the various DC voltages provided, (for example, core voltage for the SOC digital system controller 560, voltage for RAM memory, voltage for system control logic circuitry, etc.) power management IC 501 provides a voltage control output that controls the switching through the corresponding discrete inductors, capacitors and diodes to provide the appropriate voltage levels.

Power management IC 501 can also controllably provide power to the various motors 590 in the multifunction printer, including a carriage motor for the printhead, a paper advance motor, a scan assembly motor, and an ADF motor. Some or all of these motors can be run in both forward direction and reverse direction, so the motor control circuitry in power management IC 501 is typically more complex than simple on/off switches.

Printhead 250 can require two different voltages. A first voltage called printing voltage is required by the dot forming elements in order to make a mark on the recording medium. For example, for a thermal inkjet printhead, the printing voltage is the voltage used in pulsing the resistive heater in order to vaporize a portion of ink and thereby cause ejection of a drop from the drop ejector. Depending on the nominal resistance of the resistive heaters on a thermal inkjet printhead, the printing voltage is typically between about ten volts and fifty volts. It is desirable to have the energy dissipated in the resistive heaters to be at or near a predetermined value, so that the heaters will reliably nucleate vapor bubbles for drop ejection without overheating the heaters. Because resistive heater power is V²/R and resistance R can vary from printhead to printhead due to manufacturing variability, a programmable power supply 550 is sometimes used to adjust the voltage V to compensate. For example, if the nominal printing voltage is 28 volts, the programmable power supply can be adjusted to provide 30 volts, for example, for a printhead having a higher than nominal heater resistance, or 26 volts, for example, for a printhead having a lower than nominal heater resistance. Typically printing programmable power supply 550 receives its input voltage from DC power supply 520, although that connection is not shown in FIG. 8. A second voltage required by printheads 250 that have integrated logic circuitry is a printhead logic voltage, which is typically around 5 volts, and more generally between 2 volts and 6 volts. Printhead logic power supply 540 and printing programmable power supply 550 are shown as being separate from power management IC 501 in FIG. 8, but power MOSFETs and switching control circuitry for these two DC voltage sources can also be partially integrated into power management IC 501. In any case, an external on/off switch S_{P} is typically provided between printing power supply 550 and printhead 250, and an external on/off switch S_{L} is typically provided between printhead logic power supply 540 and printhead 250. Switches Sₚ and S_{L} permit printhead 250 to be disconnected from printing power supply 550 and printhead logic power supply 540 respectively during periods of inactivity in order to limit the amount of power that is used by the printhead, thereby improving energy efficiency.

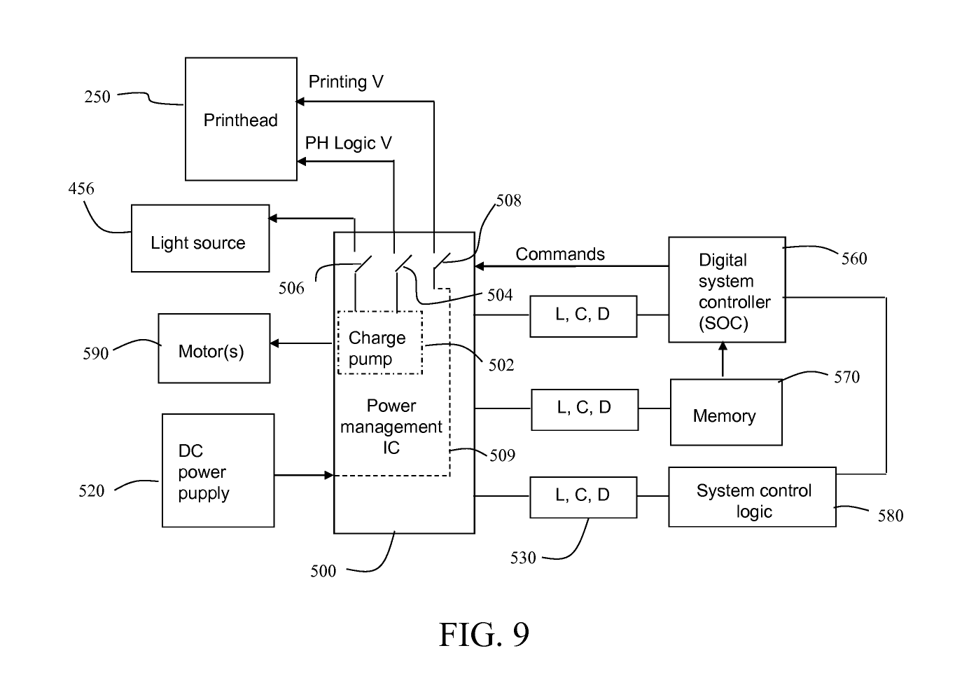

A block diagram of power management and control circuitry for a printing system according to an embodiment of the invention is shown in FIG. 9. As in the prior art of FIG. 8, discrete components 530 are provided for switching mode power supplies to convert the voltage from DC power supply 520 to the various voltage levels required for the core voltage for the digital system controller 560, memory 570, and system control logic 580. The digital system controller 560 not only receives its voltage input from the power management IC 500, but also provides commands to a digital circuitry portion of the power management IC 500. In some embodiments, the digital system controller 560 and the power management IC 500 are integrated together in a single integrated circuit device. For various DC voltages provided, (core voltage for the SOC digital system controller 560, voltage for RAM memory 570, voltage for system control logic circuitry 580, etc.) the power management IC 500 provides a voltage control output that controls the switching through the corresponding discrete inductors, capacitors and diodes to provide the appropriate voltage levels, similar to prior art power management IC 501. However, the DC voltages required for the light source 456 and for the logic voltage for printhead 250 are internally generated within the power management integrated circuit 500, thereby providing a savings of the cost and space of corresponding discrete components of inductors, capacitors and diodes (relative to FIG. 8). In particular, a charge pump 502 is integrated into power management IC 500 in order to provide the DC voltages required for the light source 456 and for the logic voltage for printhead 250. In this example, a single voltage such as 5 volts (or more generally a set voltage between 2 volts and 6 volts) is generated by charge pump 502 from a different DC voltage level, such as 30 volts, provided by DC power supply 520. An on/off switch 504 controllably connects charge pump 502 to a voltage output from power management IC 500 that is connected to the logic voltage input of printhead 250, so that logic voltage for the printhead 250 can be independently turned off when printing is not being done. An on/off switch 506 controllably connects charge pump 502 to a voltage output from power management IC 500 that is connected to light source 456, such as at least a blue LED, so that the light source voltage can be independently turned off when scanning is not being done. When neither printing nor scanning is being done, the charge pump 502 itself can be turned off by disconnecting the charge pump from the input DC voltage from DC power supply 520.

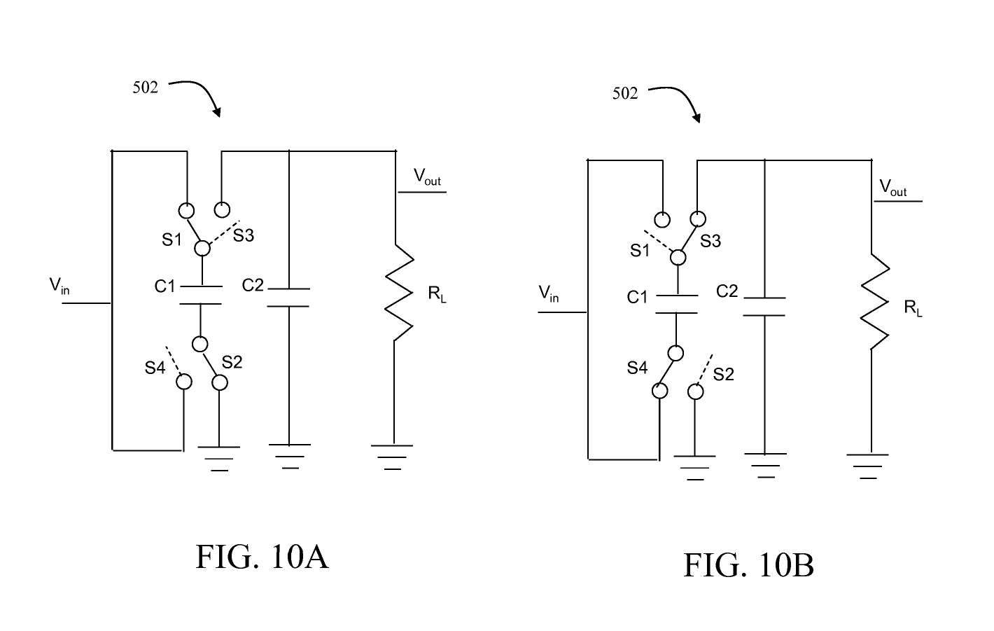

Charge pumps typically use capacitors as energy storage elements to create either a higher or a lower voltage output than the voltage input. Charge pumps use some form of switching device(s) to control the connection of voltages to the capacitors. An example of a charge pump 502 is shown in FIGS. 10A and 10B. In a first stage of operation shown in FIG. 10A, switches S1 and S2 are closed in order to connect capacitor C1 to the input voltage Vᵢₙ, while isolating capacitor C2 from Vᵢₙ. In a second stage of operation shown in FIG. 10B, switches S1 and S2 are opened, while switches S3 and S4 are closed in order to connect capacitor C2 to both Vᵢₙ and capacitor C1. Thus, capacitor C2 is being charged by both Vᵢₙ and capacitor C1. The charge pump 502 is cycled back and forth at a frequency that is typically between around 30 kHz and several Mhz. The switching circuitry, as well as the charge pump 502, are both provided on power management IC 500. If the charging cycles and discharging through the load R_{L}, are such that both capacitors C1 and C2 fully charge during a cycle, the charge pump 502 shown in FIGS. 10A and 10B can act as a voltage doubler, with Vₒᵤₜ˜2Vᵢₙ. Other charge pump circuits (not shown) can provide other ratios of Vₒᵤₜ to V_{II}, that are greater than 2 or less than 2 (or even less than 1). In addition, if C1 and C2 are not permitted to fully charge, Vₒᵤₜ is less than the value provided for the fully charged capacitor case. A feedback circuit can control the charging cycles to maintain the output voltage at a desired voltage level. Charge pumps are typically limited to relatively low current requirements, such as a current output of around 100 mA or less. Typically printhead logic requires approximately 20 to 30 mA at about 5 volts, while light source 456 typically requires approximately 30 to 50 mA at about 5 volts, so both the printhead logic voltage and the light source voltage can be provided by a single charge pump 502, as shown in FIG. 9.

Motor control functions for the multifunction printer can be provided by power management IC 500 in similar fashion to prior art power management IC 501. In particular, at least one DC motor control is connected to at least one motor in order to run the motor in forward and reverse directions, as well as to turn the motor(s) on and off.

As shown in FIG. 8, in the prior art the printing programmable power supply 550 was switched on and off by an external discrete switch S_{P}. Having such a switch is helpful for energy efficiency of the printing system because power from printing programmable power supply 550 is not being dissipated when printing is not being done. Rather than positioning the switch S_{P} between the printing programmable power supply 550 as shown in FIG. 8, switch Sₚ can instead be positioned between DC power supply 520 and printing programmable power supply 550. In the embodiment shown in FIG. 9, the on/off switch 508 for the printing voltage is incorporated into power management IC 500. In addition, in the particular example shown in FIG. 9, printing programmable power supply 550 has been completely eliminated. Instead, as indicated by a dashed line 509 inside power management IC 500, switch 508 is internally connected to the input from DC power supply 520. In other words, on/off switch 508 for the printing voltage can be simply a pass switch for the voltage from the DC power supply 520, which is a set voltage that is typically between 10 volts and 50 volts.

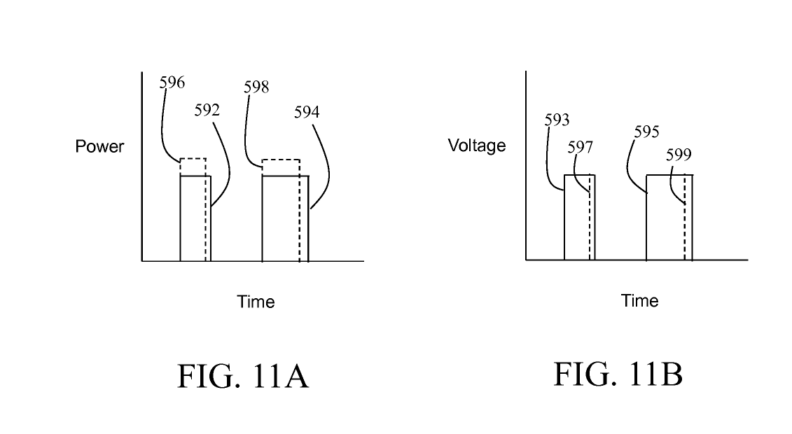

As described above relative to FIG. 8, a printing programmable power supply 550 can provide the capability of compensating for thermal inkjet printheads 250 having drop ejectors including resistive heaters that have heater resistances that are different from the nominal heater resistances, for example due to manufacturing variability. For embodiments as shown in FIG. 9 where there is no programmable power supply for the printing voltage, compensation for heater resistance variation from printhead to printhead can be compensated by modifying the pulse width. FIGS. 11A and 11B show pulse wave trains that illustrate compensation for heater resistance variations by modification of the pulse width. The type of pulse train that is used is a single prepulse that is used to locally heat the ink by an amount that depends on the printhead temperature followed by an eject pulse that heats a portion of the ink sufficiently to vaporize a portion of the ink to provide the vapor bubble that propels the ink droplet out of the printhead. FIG. 11A shows power pulses (power=V²/R) for a printhead having nominal heater resistances (solid line pulses) and for a printhead having heater resistance that is lower than nominal (dashed line pulses). In particular, FIG. 11B shows the same pulses, but shown in terms of voltage rather than power. Without a printing programmable power supply, the voltage amplitude applied for both printheads would be the same for both printheads. However, the pulse width of the prepulse and/or the eject pulse would be modified to compensate for the higher power that the printhead having lower than nominal heater resistance would experience. In particular in FIG. 11A, for a printhead having nominal heater resistance, a nominal power prepulse 592 and a nominal power eject pulse 594 would be used. For a printhead having lower than nominal heater resistance, a prepulse 596 having higher power (due to the lower resistance) would be used, but its pulsewidth would be less than that of nominal power prepulse 592. Similarly, an eject pulse 598 having higher power (due to the lower resistance) would be used, but its pulsewidth would be less than that of a nominal power eject pulse 594. In FIG. 11B, a nominal voltage prepulse 593 corresponds to a nominal power prepulse 592, nominal voltage eject pulse 595 corresponds to nominal power eject pulse 595. Similarly for a lower heater resistance printhead voltage prepulse 597 corresponds to power prepulse 596 and a voltage eject pulse 599 corresponds to power eject pulse 598. Control of the pulse width to compensate for different printhead heater resistances would be provided for example by digital system controller 560. Typically the heater resistance would be measured on the printhead 250 prior to installing it in the printer and encoded with a readable code representing a characteristic heater resistance, which can be a lowest heater resistance or an average heater resistance, for example, in the array of drop ejectors.

The invention has been described in detail with particular reference to certain preferred embodiments thereof, but it will be understood that variations and modifications can be effected within the spirit and scope of the invention.

### PARTS LIST

10 Inkjet printer system
12 Image data source
14 Controller
15 Image processing unit
16 Electrical pulse source
18 First fluid source
19 Second fluid source
20 Recording medium
100 Inkjet printhead
110 Inkjet printhead die
111 Substrate
120 First nozzle array
121 Nozzle(s)
122 Ink delivery pathway (for first nozzle array)
130 Second nozzle array
131 Nozzle(s)
132 Ink delivery pathway (for second nozzle array)
181 Droplet(s) (ejected from first nozzle array)
182 Droplet(s) (ejected from second nozzle array)
200 Carriage
250 Printhead
251 Printhead die
253 Nozzle array
254 Nozzle array direction
256 Encapsulant
257 Flex circuit
258 Connector board
262 Multi-chamber ink supply
264 Single-chamber ink supply
300 Printer chassis
301 Printing apparatus
302 Paper load entry direction
303 Print region
304 Media advance direction
305 Carriage scan direction
306 Right side of printer chassis
307 Left side of printer chassis
308 Front of printer chassis
309 Rear of printer chassis
310 Hole (for paper advance motor drive gear)
311 Feed roller gear
312 Feed roller
313 Forward rotation direction (of feed roller)
320 Pick-up roller
322 Turn roller
323 Idler roller
324 Discharge roller
325 Star wheel(s)
330 Maintenance station
370 Stack of media
371 Top piece of medium
380 Carriage motor
382 Carriage guide rail
383 Encoder fence
384 Belt
390 Printer electronics board
392 Cable connectors
400 Multifunction printer
411 Under side of automatic document feeder
412 Hinge
414 Pressing plate
430 Scanning apparatus
432 Scanning apparatus body
434 Scanning guide
435 Scanning direction
436 Frame
437 Down ramp
438 Up ramp
440 Transparent platen
442 ADF transparent platen
450 Scan assembly
452 Photosensor array
456 Light source
460 Control panel
462 Display
464 Control buttons
480 Automatic document feeder
482 Input tray
484 Output tray
486 Document feed rollers
488 Pressing member
500 Power management IC
501 Power management IC (conventional)
502 Charge pump
504 On/off switch for printhead logic voltage
506 On/off switch for light source voltage
508 On/off switch for printing voltage
509 Line (internal connection to DC power supply)
520 DC power supply
530 Discrete power supply components
540 Printhead logic power supply
550 Printing programmable power supply
560 Digital system controller
570 Memory
580 System logic
590 Various Motors
592 Nominal power prepulse
593 Nominal voltage prepulse
594 Nominal power eject pulse
595 Nominal voltage eject pulse
596 Prepulse power for low resistance heaters
597 Prepulse voltage for low resistance heaters
598 Eject pulse power for low resistance heaters
599 Eject pulse voltage for low resistance heaters

1. A printing system comprising:
a printhead including a printing voltage input and a printhead logic voltage input;
a DC power supply including a first DC voltage level; and
a power management integrated circuit comprising:
a controllably on/off voltage output connected to the printing voltage input of the printhead;
a DC to DC voltage conversion circuit to internally generate a second DC voltage level that is different from the first DC voltage level; and
a controllably on/off voltage output connected to the printhead logic voltage input.

2. The printing system of claim 1, wherein the power management integrated circuit includes a charge pump for internally generating the printhead logic power supply voltage.

3. The printing system of claim 1 further comprising random access memory including a voltage input, wherein the power management integrated circuit further provides a voltage control output for the random access memory.

4. The printing system of claim 1 further comprising a digital system controller including a core voltage input, wherein the power management integrated circuit further provides a voltage control output for the core voltage of the digital system controller.

5. The printing system of claim 4, the power management integrated circuit further comprising a digital circuitry portion, wherein the digital system controller includes a command output connected to the digital circuitry portion of the power management integrated circuit.

6. The printing system of claim 1 further comprising system control logic circuitry including a voltage input, wherein the power management integrated circuit further provides a voltage control output for the system control logic circuitry.

7. The printing system of claim 1, wherein the controllably on/off voltage output connected to the printing voltage input of the printhead provides a set voltage between 10 volts and 50 volts.

8. The printing system of claim 1, wherein the controllably on/off voltage output connected to the logic voltage input of the printhead provides a set voltage between 2 volts to 6 volts.

9. The printing system of claim 1, wherein the power management integrated circuit and the digital system controller are integrated together within the same integrated circuit device.

10. The printing system of claim 1, wherein the printhead is an inkjet printhead including a drop ejector, and the printing voltage is a voltage suitable for ejecting a drop of ink from the drop ejector.

11. The printing system of claim 9, wherein the drop ejector includes a resistive heater.

12. The printing system of claim 1 further comprising a scanning apparatus including a photosensor array and a light source, wherein the power management integrated circuit includes a charge pump for internally generating a power supply voltage for the light source.

13. The printing system of claim 1 further comprising a scanning apparatus including a photosensor array and a light source, wherein the power management integrated circuit includes a charge pump for internally generating a power supply voltage for the light source and for internally generating the printhead logic voltage.

14. The printing system of claim 13, wherein the power management integrated circuit further comprises:
a first switch disposed between the charge pump and the output for the printhead logic voltage; and
a second switch disposed between the charge pump and an output for the light source voltage.

15. The printing system of claim 1 further comprising at least one motor, wherein the power management IC further comprises a DC motor control connected to the at least one motor.

16. The printing system of claim 1, wherein the controllably on/off voltage output of the power management integrated circuit that is connected to the printing voltage input of the printhead comprises an on/off switch connected to the first DC voltage level.

17. The printing system of claim 16, the printhead further including a resistive heater for ejecting drops of ink, the printing system further comprising a controller, wherein the controller is configured to modify widths of printing pulses provided to the printhead based on a resistance of the resistive heater.
